(19) United States
(12) Patent Application Publication
(10) Pub. No.: US 2011/0073016 A1
(43) Pub. Date: Mar. 31, 2011

(54) HEAVYWEIGHT AGGREGATE AND HEAVYWEIGHT CONCRETE

(76) Inventors: Minoru Yoshimoto, Chiba (JP); Yasuhide Higo, Chiba (JP); Eichi Manabe, Chiba (JP)

(21) Appl. No.: 12/521,088

(22) PCT Filed: Jan. 16, 2009
(86) PCT No.: PCT/JP2009/050576

§ 371 Date: Jun. 24, 2009

(30) Foreign Application Priority Data
May 23, 2008 (JP) 2008 135958

(51) Int. Cl. C04B 7/00

(52) U.S. Cl. 106/816

(57) ABSTRACT

The invention has an object to provide a heavyweight fine aggregate and a heavyweight aggregate for a stiff heavyweight concrete having a slump of 0 to 3 cm, in which segregation from the cement paste is unlikely to occur, and to provide a stiff heavyweight concrete having a slump of 0 to 3 cm, using the heavyweight fine aggregate and heavyweight aggregate. The heavyweight fine aggregate comprises no less than 20 wt % of aggregate having a particle size smaller than 0.15 mm, and no less than 20 wt % of aggregate having a particle size from 2.5 mm to less than 5 mm. The above feature allows effectively inhibiting segregation between the aggregate and cement paste when blending the aggregate into the heavyweight concrete, and allows effectively increasing the filling rate in boxes when blending the aggregate into the heavyweight concrete for box filling.

### TECHNICAL FIELD

The present invention relates to a heavyweight aggregate comprising a heavyweight fine aggregate, and to a heavyweight concrete using the heavyweight aggregate.

### BACKGROUND ART

Heavyweight concrete denotes concrete having a large weight per unit volume, resulting from using a heavyweight aggregate having a greater specific gravity than aggregates used in ordinary concretes. Heavyweight concrete is used as concrete for radiation shielding, in wave-dissipating blocks, as concrete for levee revetments, or as concrete for filling in counterweight of construction machinery, industrial machinery or the like. Ordinarily, the unit water content of concrete is increased to raise the slump value, with a view to ensuring the flowability and workability of the concrete. Increasing the unit water content of heavyweight concrete, however, results in a lower heavyweight concrete density, and gives rise to segregation between cement paste and heavyweight aggregate, caused by sinking of the heavyweight aggregate. For this reason, heavyweight concretes ordinarily used are stiff heavyweight concretes having a reduced unit water content and a reduced slump value.

The heavyweight aggregates used in such heavyweight concrete conventionally include artificial heavyweight aggregates such as scrap iron; natural heavyweight aggregates such as magnetite, hematite, iron sand or the like. These heavyweight aggregates have a large density difference vis-à-vis cement pastes. Moreover, iron ores such as magnetite, hematite or the like have in particular a comparatively coarse particle size distribution. Therefore, the viscosity of concrete is likelier to decrease when using such iron ores as heavyweight aggregate. Thus, conventional heavyweight concretes have been beset by the problem of sinking of heavyweight aggregate, which has a large particle size, within the cement paste, which results in segregation between the cement paste and the heavyweight aggregate.

To solve the above problem, a heavyweight concrete has been proposed having blended therein 20 to 60 kg, per m³ of concrete, of ultrafine powder comprised in an iron ore (Patent document 1).
Patent document 1: Japanese Patent Application Laid-open No. 7-25654

### DISCLOSURE OF THE INVENTION

### Problem to be Solved by the Invention

The invention set forth in Patent document 1 aims at inhibiting segregation between cement paste and heavyweight aggregate by using a predetermined iron ore as the heavyweight aggregate. However, this is problematic in that iron ore prices have risen sharply in recent years on account of iron resource shortages. This translates into a steep increase in the cost of the resulting heavyweight concrete.

In the light of the above, it is an object of the present invention to provide a heavyweight fine aggregate and a heavyweight aggregate little prone to segregation from a cement paste, as heavyweight aggregates for replacing conventionally used iron ores, and to provide a heavyweight concrete using such heavyweight fine aggregate and heavyweight aggregate.

### Means for Solving the Problem

In order to solve the above problems, the present invention provides a heavyweight fine aggregate for a stiff heavyweight concrete having a slump of 0 to 3 cm, comprising no less than 20 wt % of aggregate having a particle size smaller than 0.15 mm, and no less than 20 wt % of aggregate having a particle size from 2.5 mm to less than 5 mm (Invention 1).

Ordinarily, the concrete fine aggregate that is used has preferably a particle size distribution with no bias, so as to bring about desired workability and strength using small cement amounts, and so as to prevent segregation. Specifically, although concrete fine aggregates are supposed to have preferably the particle size distributions prescribed in JIS-A5005, the heavyweight fine aggregate of the above invention (Invention 1) has a particle size distribution biased to aggregate (fine particle fraction) having a particle size smaller than 0.15 mm, and aggregate (coarse particle fraction) having a particle size from 2.5 mm to less than 5 mm. Such a particle size distribution allows providing a heavyweight fine aggregate that yields sufficient weight per unit volume in the heavyweight concrete, without segregation during blending into the concrete. When such heavyweight fine aggregate is used, in particular, as a fine aggregate of heavyweight concrete in counterweights or the like, the filling rate of the heavyweight concrete in counterweight boxes can be increased by causing the fine aggregate to comprise no less than 20 wt % of aggregate having a particle size smaller than 0.15 mm. Further, causing the heavyweight fine aggregate to comprise no less than 20 wt % of aggregate having a particle size from 2.5 mm to less than 5 mm allows preventing loss of flowability in the heavyweight concrete during concrete blending.

In the present invention, the particle size of the aggregate is determined on the basis of whether the aggregate passes or not through a sieve of predetermined nominal size. For instance, aggregate having a particle size smaller than 0.15 mm denotes an aggregate passing through a sieve of 0.15 mm nominal size, while aggregate having a particle size from 2.5 mm to less than 5 mm denotes an aggregate passing through a sieve of 5 mm nominal size but not through a sieve of 2.5 mm nominal size. In the present invention, heavyweight aggregate (encompassing heavyweight coarse aggregate and heavyweight fine aggregate) denotes an aggregate having a density of 3.5 g/cm³ or higher.

In the above invention (Invention 1), preferably, the heavyweight fine aggregate is partly or entirely barite (Invention 2). The particle size of a fine aggregate obtained through crushing of a predetermined barite is biased towards a coarse particle fraction and a fine particle fraction. As a result, such an invention (Invention 2) allows obtaining a heavyweight fine aggregate that can afford sufficient weight in a heavyweight concrete, by simply crushing a barite, without any special particle size adjustment, and without occurrence of segregation during blending into the concrete.

Also, the present invention provides a heavyweight aggregate for a stiff heavyweight concrete having a slump of 0 to 3 cm, comprising the heavyweight fine aggregate according to the above inventions (Inventions 1 and 2) and a coarse aggregate (Invention 3). Such an invention (Invention 3) allows providing a heavyweight aggregate that can afford sufficient weight in a heavyweight concrete, without occurrence of segregation during blending into the concrete.

In the above invention (Invention 3), preferably, there is comprised no less than 5 wt % of ultrafine aggregate having a particle size smaller than 0.075 mm (Invention 4). By including no less than 5 wt % of ultrafine aggregate having a particle size smaller than 0.075 mm, such an invention (Invention 4) allows increasing cement paste viscosity, and by increasing paste density, allows reducing the density difference (density difference: 2.5 g/cm³ or less) between the paste and the aggregate (aggregate having a particle size of 0.075 mm or greater). As a result, this allows inhibiting yet more effectively segregation in the heavyweight concrete, which in turn allows further increasing the filling rate of heavyweight concrete in counterweight boxes when the heavyweight aggregate is used as an aggregate of a heavyweight concrete for counterweights or the like.

In the above inventions (Inventions 3 and 4), preferably, the coarse aggregate is partly or entirely barite (Invention 5), and the heavyweight fine aggregate and the coarse aggregate are preferably obtained by crushing barite to a largest particle size of, for instance, 20 to 70 mm (Invention 6).

In the above inventions (Inventions 5 and 6), when the heavyweight aggregate, which is obtained by coarsely crushing barite in accordance with an ordinarily employed method, is blended into the concrete, segregation is inhibiting yet more effectively. In particular, the above invention (Invention 6) allows manufacturing, in a simple way, a heavyweight aggregate having a predetermined fine aggregate particle size distribution (no less than 20 wt % of aggregate having a particle size smaller than 0.15 mm and no less than 20 wt % of aggregate having a particle size from 2.5 mm to less than 5 mm), without any special particle size adjustment or the like, by crushing barite to a largest particle size of 20 to 70 mm. The invention affords also a heavyweight aggregate that allows inhibiting yet more effectively segregation when the heavyweight aggregate is blended into the concrete.

In the above inventions (Inventions 5 and 6), preferably, the average tensile strength of aggregate having a particle size of 9 to 11 mm, obtained through crushing of the barite, is 4.0 to 10.0 N/mm² (Invention 7). Prescribing the average tensile strength of aggregate having a particle size of 9 to 11 mm, obtained through crushing of barite, to range from 4.0 to 10.0 N/mm², as in such an invention (Invention 7), makes it possible to easily obtain a heavyweight aggregate having a predetermined fine aggregate particle size distribution (no less than 20 wt % of aggregate having a particle size smaller than 0.15 mm and no less than 20 wt % of aggregate having a particle size from 2.5 mm to less than 5 mm) by simply coarsely crushing such a barite during the manufacture of the aggregate. As a result, this allows omitting a particle size adjustment operation, and allows reducing the manufacturing costs of the heavyweight aggregate.

The present invention further provides a stiff heavyweight concrete, having a slump of 0 to 3 cm, comprising the heavyweight fine aggregate according to the above inventions (Inventions 1 and 2) or the heavyweight aggregate according to the above inventions (Inventions 3 to 7), cement, and water (Invention 8).

The above invention (Invention 8) allows providing a heavyweight concrete in which material segregation can be inhibited. When the heavyweight concrete is used, in particular, as a heavyweight concrete for filling in counterweight or the like, the invention allows effectively increasing the filling rate of the heavyweight concrete in counterweight boxes.

In the above invention (Invention 8), preferably, the water-cement ratio is 30 to 60% (Invention 9). By causing the water cement ratio to lie within the above range, such an invention (Invention 9) allows obtaining a high-density heavyweight concrete, having a small unit water content, while ensuring the workability of the heavyweight concrete.

### ADVANTAGEOUS EFFECT OF THE INVENTION

The present invention allows providing a heavyweight fine aggregate and heavyweight aggregate little prone to segregate from a cement paste, and providing a heavyweight concrete using such a heavyweight fine aggregate and heavyweight aggregate.

### BRIEF DESCRIPTION OF THE DRAWINGS

FIG. 1 is a graph illustrating results of tensile strength tests of aggregates according to Example 1, Example 2, Comparative example 1 and Comparative example 4; and

FIG. 2 is a graph illustrating results of tensile strength tests of aggregates according to Example 1 and Comparative examples 4 to 6.

### BEST MODE FOR CARRYING OUT THE INVENTION

Embodiments of the present invention are explained in detail below.

[Heavyweight Aggregate]

The heavyweight aggregate according to the present embodiment comprises a heavyweight fine aggregate having a predetermined particle size distribution, and a coarse aggregate.

The heavyweight fine aggregate comprises no less than 20 wt % of aggregate having a particle size smaller than 0.15 mm, and no less than 20 wt % of aggregate having a particle size from 2.5 mm to less than 5 mm. Preferably, the heavyweight fine aggregate comprises no less than 20 wt % of aggregate having a particle size smaller than 0.15 mm, and no less than 25 wt % of aggregate having a particle size from 2.5 mm to less than 5 mm.

Occurrence of segregation from the cement paste, during blending into the heavyweight concrete, can be effectively prevented when the content of aggregate having a particle size smaller than 0.15 mm is no less than 20 wt % in the heavyweight fine aggregate. Also, a desired workability can be ensured, without loss of concrete flowability during blending into the heavyweight concrete, when the content of aggregate having a particle size from 2.5 mm to less than 5 mm is no less than 20 wt %. Such aggregate contents allow effectively improving the filling rate of the heavyweight concrete, into counterweight boxes or the like, when such heavyweight concrete for filling in counterweight comprises a heavyweight fine aggregate, and allows increasing compactability by vibration or the like, without occurrence of segregation.

As the coarse aggregate comprised in the heavyweight aggregate there may be used a heavy coarse aggregate or a coarse aggregate such as crushed stone, gravel or the like, ordinarily used in concrete, so long as the heavyweight concrete has a desired weight when the coarse aggregate is blended into the heavyweight concrete.

The heavyweight aggregate according to the present embodiment comprises preferably no less than 5 wt %, more preferably 5 to 10 wt %, and in particular 5 to 8 wt % of a fine-powder aggregate having a particle size smaller than 0.075 mm. A content of no less than 5 wt % of such a fine-powder aggregate allows improving the viscosity of the cement paste in the heavyweight concrete, and allows increasing the density of paste, since, for instance, the density of the above-described fine-powder aggregate is 3.5 g/cm³ or higher, compared to 3.16 g/cm³ for ordinary Portland cement. Segregation between the paste and the aggregate can be further inhibited as a result.

In the present embodiment, barite can be used as the natural ore that is the raw material of the heavyweight aggregate. Barite, which has a density of about 4.0 g/cm³, has sufficient density to be used as a heavyweight aggregate. Also, a heavyweight aggregate obtained by crushing barite comprises a substantial amount of fine-powder aggregate having a particle size smaller than 0.075 mm. This allows, as a result, reducing the density difference between paste and aggregate (density difference: 2.5 g/cm³ or less), which in turn allows further inhibiting segregation between the paste and the heavyweight aggregate obtained from the barite.

When using barite as the raw material in the manufacture of the heavyweight aggregate, the barite used is preferably a barite that yields an average tensile strength of 4.0 to 10.0 N/mm², more preferably a barite that yields an average tensile strength of 4.0 to 8.0 N/mm², in an aggregate having a particle size of 9 to 11 mm resulting from coarse crushing of the barite. A heavyweight aggregate having a desired fine aggregate particle size distribution (a content of no less than 20 wt % of aggregate having a particle size smaller than 0.15 mm, and a content of no less than 20 wt % of aggregate having a particle size from 2.5 mm to less than 5 mm) can be obtained by just coarsely crushing a barite such that an obtained aggregate having a particle size of 9 to 11 mm has an average tensile strength lying within the above range. Therefore, the manufacturing process of the heavyweight aggregate can be simplified, since particle size need not be adjusted after coarse crushing, and thus the manufacturing costs of the heavyweight aggregate can be reduced.

The heavyweight aggregate according to the present embodiment can be manufactured through coarse crushing of the natural ore used as the raw material of the heavyweight aggregate, to a largest particle size of 20 to 70 mm, preferably of 20 to 50 mm, in the obtained heavyweight aggregate, using a crusher (for instance, a jaw crusher) or the like.

After coarse crushing of the natural ore, the particle size of the obtained heavyweight aggregate may be adjusted so as to yield a predetermined fine particle size distribution (a content of no less than 20 wt % of aggregate having a particle size smaller than 0.15 mm, and a content of no less than 20 wt % of aggregate having a particle size from 2.5 mm to less than 5 mm). However, a heavyweight aggregate having a desired fine aggregate particle size distribution (a content of no less than 20 wt % of aggregate having a particle size smaller than 0.15 mm, and a content of no less than 20 wt % of aggregate having a particle size from 2.5 mm to less than 5 mm) and comprising no less than 5 wt % of fine-powder aggregate having a particle size smaller than 0.075 mm can be obtained by just coarsely crushing the above-described barite. This allows, therefore, omitting the step of adjusting particle size after coarse crushing of the natural ore, and allows thus reducing the manufacturing costs of the heavyweight aggregate.

[Heavyweight Concrete]

The heavyweight concrete according to the present embodiment comprises the above-described heavyweight aggregate, cement and water.

The cement comprised in the heavyweight concrete according to the present embodiment is not particularly limited. As the cement there may be used, for instance, Portland cements such as ordinary Portland cement, high-early strength Portland cement, moderate-heat Portland cement, low-heat Portland cement; mixed cements such as blast furnace slag cement and fly ash cement; and cements (eco-cements) comprising gypsum and a pulverized product of a burned product manufactured using urban-waste incineration ash and/or sewage sludge incineration ash as raw materials.

Various chemical admixtures (such as water-reducing agents, defoaming agents and the like) may be added, as desired, to the heavyweight concrete according to the present embodiment. The unit water content of the heavyweight concrete must be reduced to ensure high density, and hence addition of a water-reducing agent is particularly preferred. Although not particularly limited, examples of the water-reducing agent include, for instance, lignin type, naphthalene sulfonate type, melamine type, polycarboxylic acid type water-reducing agents, AE water-reducing agents, high-performance water-reducing agents, high-performance AE water-reducing agents and the like. A defoaming agent is preferably added, in particular, when entrainment of air is to be curtailed, with a view to ensuring a high density in the heavyweight concrete.

The heavyweight concrete according to the present embodiment can be manufactured by mixing the above-described heavyweight aggregate and cement, followed by addition of water, and mixing in accordance with a known method.

The water-cement ratio in the heavyweight concrete according to the present embodiment is not particularly limited, but ranges preferably from 30 to 60%, more preferably from 35 to 50%. A water-cement ratio lying within the above range allows obtaining a high-density heavyweight concrete having a small unit water content, while ensuring the workability of the heavyweight concrete.

The fine aggregate ratio (s/a) of the heavyweight concrete according to the present embodiment ranges preferably from 40 to 60%. Moreover, the blend of the various concrete raw materials is preferably determined in such a manner so as to achieve a slump of 0 to 3 cm during mixing.

The heavyweight concrete thus obtained can be used as a heavyweight concrete in wave-dissipating blocks, levee revetments, radiation shielding walls and bridge counterweights, but is particularly useful in applications where vibro-compaction is carried out, with stiff consistency, to a slump of 0 to 3 cm, and can be used, for instance, as a heavyweight concrete for filling in counterweight.

When used, for instance, as a heavyweight concrete for filling in boxes of counterweights or the like, the heavyweight concrete according to the present embodiment is flowed into the box of the counterweight or the like and is then vibration-molded. The viscosity of the heavyweight concrete can be raised then by increasing the microparticle fraction (aggregate of particle size smaller than 0.15 mm) in the heavyweight concrete. The flowability of the heavyweight concrete does not decrease at that time, thanks to the larger content of coarse particle fraction (aggregate having a particle size from 2.5 mm to less than 5 mm). This allows increasing the filling rate of the heavyweight concrete in the boxes, and allows further inhibiting segregation between the cement paste and the heavyweight aggregate in the heavyweight concrete during vibration molding.

As explained above, the heavyweight fine aggregate and the heavyweight aggregate according to the present embodiment allow effectively inhibiting segregation from the cement paste. When used as heavyweight concrete for filling in counterweight boxes or the like, in particular, the heavyweight concrete according to the present embodiment allows effectively increasing the filling rate of the heavyweight concrete in the boxes.

### EXAMPLES

The present invention is explained in detail next based on examples, although the invention is in no way limited to the following examples.

[Manufacture of a Heavyweight Aggregate]

Heavyweight aggregates (Examples 1 to 2, Comparative examples 1 to 3) were manufactured by charging respective barites, shown in Table 1, into a jaw crusher (trade name Fine Jaw Crusher, by Maekawa Kogyosho) and crushing the barites in such a manner that the obtained aggregates had a largest particle size of 40 mm.

TABLE 1

| | Type | Summary |
|---|---|---|
| Example 1 | Fine | Barite (1), saturated surface dry |
| | aggregate | density: 4.12 g/cm³ |
| | Coarse | Barite (1), saturated surface dry |
| | aggregate | density: 4.04 g/cm³ |
| Example 2 | Fine | Barite (2), saturated surface dry |
| | aggregate | density: 3.94 g/cm³ |
| | Coarse | Barite (2), saturated surface dry |
| | aggregate | density: 3.67 g/cm³ |
| Comp. | Fine | Barite (3), saturated surface dry |
| example 1 | aggregate | density: 4.04 g/cm³ |
| | Coarse | Barite (3), saturated surface dry |
| | aggregate | density: 4.20 g/cm³ |
| Comp. | Fine | Barite (1) + (3), saturated surface dry |
| example 2 | aggregate | density: 4.08 g/cm³ |
| | Coarse | Barite (1) + (3), saturated surface dry |
| | aggregate | density: 4.12 g/cm³ |
| Comp. | Fine | Barite (2) + (3), saturated surface dry |
| example 3 | aggregate | density: 3.99 g/cm³ |
| | Coarse | Barite (2) + (3), saturated surface dry |
| | aggregate | density: 3.94 g/cm³ |

The heavyweight fine aggregate in the heavyweight aggregates thus obtained (Examples 1 to 2, Comparative examples 1 to 3) was screened through sieves having nominal sizes ranging from 0.15 to 5.0 mm, to measure the weight ratios (wt %) of the aggregates passing through the various sieves. The content (wt %) of aggregate having a particle size smaller than 0.075 mm was also measured in the above-described heavyweight aggregates (Examples 1 to 2, Comparative examples 1 to 3). The results are shown in Table 2.

TABLE 2

| | | | | | | | Content of aggregate with |
|---|---|---|---|---|---|---|---|
| | Nominal size (mm) | | | | | | particle size smaller |
| | 5.0 | 2.5 | 1.2 | 0.6 | 0.3 | 0.15 | than 0.075 mm (wt %) |
| Example 1 | 95 | 73 | 58 | 51 | 43 | 29 | 5.2 |
| Example 2 | 98 | 67 | 45 | 35 | 27 | 21 | 5.8 |
| Comp. | 100 | 94 | 77 | 52 | 29 | 13 | 4.1 |
| example 1 | | | | | | | |
| Comp. | 98 | 83 | 68 | 52 | 36 | 21 | 4.7 |
| example 2 | | | | | | | |
| Comp. | 99 | 79 | 61 | 44 | 28 | 17 | 4.9 |
| example 3 | | | | | | | |

As shown in Table 2, the heavyweight fine aggregates of Examples 1 and 2, contained no less than 20 wt % of aggregate having a particle size smaller than 0.15 mm, and no less than 20 wt % of aggregate having a particle size from 2.5 mm to less than 5 mm, whereas the heavyweight fine aggregate of Comparative example 1 contained less than 20 wt % of both types of aggregate. The heavyweight fine aggregate of Comparative example 2 contained less than 20 wt % of aggregate having a particle size from 2.5 mm to less than 5 mm, while the heavyweight fine aggregate of Comparative example 3 contained less than 20 wt % of aggregate having a particle size smaller than 0.15 mm. The heavyweight aggregates of Examples 1 and 2 contained no less than 5 wt % of fine-powder aggregate having a particle size smaller than 0.075 mm, whereas the heavyweight aggregates of Comparative examples 1 to 3 contained less than 5 wt % of such heavyweight aggregate.

[Test for Measuring the Tensile Strength of the Heavyweight Aggregates]

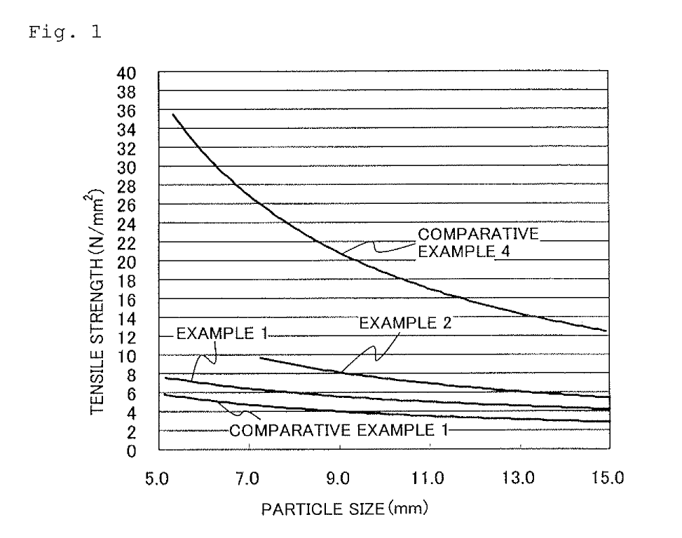

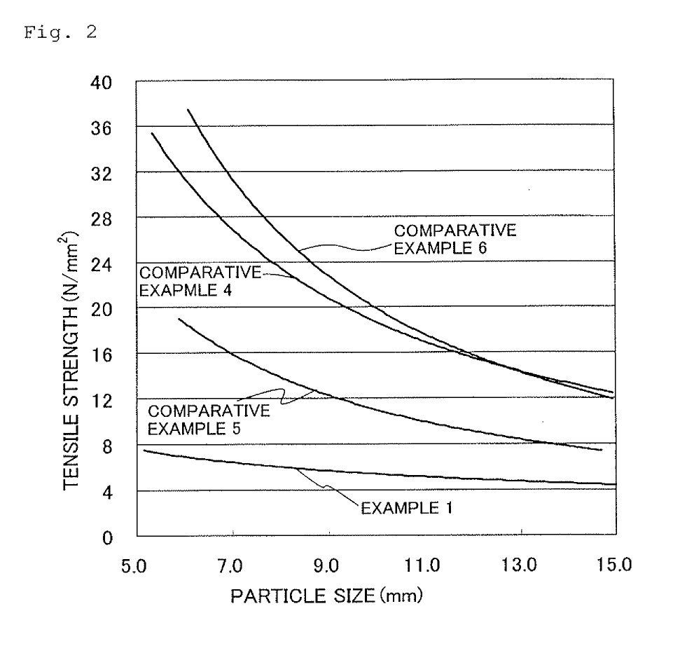

The heavyweight aggregates obtained as described above (Example 1, Example 2 and Comparative example 1) were subjected to a point load test in accordance with the standard “Point Load Test Method in Rocks” (JCS 3421-2005) of the Japanese Geotechnical Society. In the present test example there was determined the tensile strength (N/mm²), with a view to ascertaining the strength of the aggregates more easily. For comparison purposes, tensile strength was also determined, in the same way, for a metal slag aggregate (trade name DSM aggregate, by Taiheiyo Cement, Comparative example 4), limestone (Comparative example 5), and hard sandstone (Comparative example 6). The aggregates of Comparative examples 4 to 6 were manufactured through coarse crushing in the same way as in Examples 1 to 2 and Comparative examples 1 to 3, but to a largest particle size of 20 mm in the obtained aggregates. The results are illustrated in FIGS. 1 and 2.

As illustrated in FIGS. 1 and 2, the average tensile strength of aggregate having a particle size of 9 to 11 mm, in the aggregates of Examples 1 and 2, ranged from 4.0 to 10.0 N/mm². By contrast, the average tensile strength of aggregate having a particle size of 9 to 11 mm, in the aggregate of Comparative example 1, was smaller than 4.0 N/mm². This indicated that a heavyweight fine aggregate containing no less than 20 wt % of aggregate having a particle size smaller than 0.15 mm and containing no less than 20 wt % of aggregate having a particle size from 2.5 mm to less than 5 mm can be manufactured, and a heavyweight aggregate comprising such a heavyweight fine aggregate can also be manufactured, without carrying out any special particle size adjustment or the like, by using a barite such that the average tensile strength of aggregate having a particle size of 9 to 11 mm, in the aggregates obtained through coarse crushing, ranges from 4.0 to 10.0 N/mm². The results indicated also that a heavyweight aggregate comprising no less than 5 wt % of a fine-powder aggregate having a particle size smaller than 0.075 mm can be manufactured by using a barite such that the average tensile strength of aggregate having a particle size of 9 to 11 mm, in the aggregates obtained through coarse crushing, ranges from 4.0 to 10.0 N/mm².

As illustrated in FIGS. 1 and 2, the tensile strength of the heavyweight aggregates of Examples 1 and 2 lay within a range from 4.0 to 10.0 N/mm², almost independently of particle size. By contrast, the tensile strength of the aggregates of Comparative examples 4 to 6 increased as the particle size became smaller. In all the Comparative examples 4 to 6, the fine aggregate having a particle size of 5 mm or less tended to exhibit a large particle size, with a content of less than 20 wt % of aggregate having a particle size smaller than 0.15 mm. This suggests that a heavyweight aggregate having a desired particle size distribution can be manufactured, without any special particle size adjustment, by using a natural ore (for instance, barite) such that the tensile strength of the obtained aggregate falls within a predetermined range (4.0 to 10.0 N/mm²), virtually independently of particle size.

[Manufacture of a Heavyweight Concrete]

Heavyweight concretes were manufactured by mixing the blends shown in Table 3, comprising heavyweight aggregates obtained as described above (heavyweight fine aggregate S heavyweight coarse aggregate G), ordinary Portland cement C (by Taiheiyo Cement, density 3.16 g/cm³) and water W. The blends of the heavyweight concretes of Examples 1 to 2 and Comparative examples 1 to 3 were determined so as to yield a slump value of 0 to 1.0 cm, as measured in accordance with JIS-A1101. Mixing water was insufficient in the heavyweight concretes of Comparative examples 1 to 3, and hence adjustment water W′ was supplementarily added to achieve a slump similar to that of Examples 1 to 2.

TABLE 3

| | W/C | s/a | Air | Unit amount (kg/m³) | | | | | Weight per unit |
|---|---|---|---|---|---|---|---|---|---|
| | (%) | (%) | (%) | W | W′ | C | S | G | volume (kg/L) |
| Example 1 | 42 | 45 | 2.0 | 120 | 0 | 286 | 1426 | 1709 | 3.541 |
| Example 2 | | | | 120 | 0 | 286 | 1363 | 1552 | 3.321 |
| Comp. | | | | 120 | 15 | 286 | 1398 | 1777 | 3.581(3.528) |
| example 1 | | | | | | | | | |
| Comp. | | | | 120 | 15 | 286 | 1412 | 1743 | 3.561(3.508) |
| example 2 | | | | | | | | | |
| Comp. | | | | 120 | 15 | 286 | 1381 | 1667 | 3.454(3.403) |
| example 3 | | | | | | | | | |

* In the table, W′ denotes “amount of additional adjustment water on account of insufficient mixing water”.
* The “figures in parentheses” in the weight per unit volume shown in the table denote values corrected after addition of adjustment water.

Measurement of the VC (Vibrating Consolidation) Value and Measurement of the Compaction Rate

The heavyweight concretes obtained above (Examples 1 to 2, Comparative examples 1 to 3) were measured for VC (Vibrating consolidation) value in accordance with JSCE-F507 “Consistency Test Methods in RCD Concrete”. The results are shown in Table 4. The VC value, which denotes the time required for compaction upon applying vibration to the concrete, allows evaluating workability in that workability becomes better as the VC value decreases.

The weight per unit volume of the heavyweight concretes, after compaction in the above test, was measured, and the compaction rate (%) was calculated based on the proportion relative to the design value of the weight per unit volume. The results are summarized in Table 4. Presence or absence of cement paste scumming was further determined by visual observation of the heavyweight concretes after being compacted as described above. The results are summarized in Table 4.

TABLE 4

| | | Consistency test | | |
|---|---|---|---|---|
| | Slump | VC value | Compaction | Cement paste |
| | (cm) | (sec) | rate (%) | scumming |
| Example 1 | 0.0 | 12.6 | 99.2 | No |
| Example 2 | 1.0 | 10.5 | 99.1 | No |
| Comp. | 0.5 | 16.5 | 90.7 | Yes |
| example 1 | | | | |
| Comp. | 0.0 | 18.6 | 98.6 | No |
| example 2 | | | | |
| Comp. | 1.0 | 9.6 | 96.0 | Some |
| example 3 | | | | |

As shown in Table 4, the VC value in Comparative example 1 was higher than the VC value in Example 1 and Example 2, which was indicative of lower heavyweight concrete flowability. This showed that the heavyweight concretes of both Example 1 and Example 2 had good workability. As the results of the visual observation after compaction clearly show, the heavyweight concrete of Comparative example 1 exhibited pronounced cement paste scumming, pointing at the occurrence of segregation between the cement paste and the heavyweight aggregate.

On the other hand, the compaction rate of the heavyweight concrete of Comparative example 1 was 2% or more lower than that of the heavyweight concretes of Example 1 and Example 2. This result is thought to arise from occurrence of segregation in the heavyweight concrete of Comparative example 1, which causes the heavyweight aggregate, having a greater specific gravity, to sink to the bottom of the container, with an accompanying drop in the filling rate. By contrast, the heavyweight concretes of Example 1 and Example 2, in which no segregation occurs, allow effectively increasing the filling rate.

The heavyweight concrete of Comparative example 2 had a yet higher VC value, and lower flowability during vibration molding. Presumably, that is because the heavyweight concrete of Comparative example 2 has a content of less than 20 wt % of aggregate having a particle size from 2.5 mm to less than 5 mm in the heavyweight fine aggregate, which makes for a finer aggregate as a whole, and results in lower heavyweight concrete flowability.

Although the heavyweight concrete of Comparative example 3 exhibits a VC value similar to that of the heavyweight concretes of Example 1 and Example 2, and boasts hence good workability, it has a content of less than 20 wt % of aggregate having a particle size smaller than 0.15 mm in the heavyweight fine aggregate. As a result, there occurs some segregation, with sinking of heavyweight aggregate having a comparatively large particle size, which is thought to result in a drop in the compaction rate.

### INDUSTRIAL APPLICABILITY

The heavyweight fine aggregate and heavyweight aggregate of the present invention are useful as aggregates for heavyweight concrete having good workability and filling ability. The heavyweight concrete of the present invention is particularly useful as a heavyweight concrete for vibration molding, in which the concrete is filled into counterweight boxes or the like.

1. A heavyweight fine aggregate for a stiff heavyweight concrete having a slump of 0 to 3 cm, comprising no less than 20 wt % of an aggregate having a particle size smaller than 0.15 mm, and no less than 20 wt % of an aggregate having a particle size from 2.5 mm to less than 5 mm.

2. The heavyweight fine aggregate according to claim 1, wherein said heavyweight fine aggregate is partly or entirely barite.

3. A heavyweight aggregate for a stiff heavyweight concrete having a slump of 0 to 3 cm, comprising the heavyweight fine aggregate according to claim 1, and a coarse aggregate.

4. The heavyweight aggregate according to claim 3, wherein said heavyweight fine aggregate and said coarse aggregate comprise no less than 5 wt % of an ultrafine aggregate having a particle size smaller than 0.075 mm.

5. The heavyweight aggregate according to claim 3, wherein said coarse aggregate is partly or entirely barite.

6. The heavyweight aggregate according to claim 3, wherein said heavyweight fine aggregate and said coarse aggregate are obtained by crushing barite to a largest particle size of 20 to 70 mm.

7. The heavyweight aggregate according to claim 5, wherein the average tensile strength of an aggregate having a particle size of 9 to 11 mm, obtained through crushing of said barite, is 4.0 to 10.0 N/mm².

8. A stiff heavyweight concrete having a slump of 0 to 3 cm, comprising: the heavyweight fine aggregate according to claim 1, cement, and water.

9. The heavyweight concrete according to claim 8, wherein the water-cement ratio is 30 to 60%.
